(19) United States
(12) Patent Application Publication
(10) Pub. No.: US 2016/0012468 A1
(43) Pub. Date: Jan. 14, 2016

(54) PRODUCT-CLASS-BASED INCENTIVIZED TRANSACTION

(71) Applicant: THE TORONTO-DOMINION BANK, Mississauga (CA)

(72) Inventors: Lauren van Heerden, Bedford, NH (US); Orin Del Vecchio, Richmond Hill (CA); Gunalan Nadarajah, Milton (CA); Paul Mon-Wah Chan, Markham (CA); Steve Robert Langham, London (CA); Jonathan K. Barnett, Oakville (CA); Jakub Danielak, Toronto (CA); Roisin Fritz, Toronto (CA); John Jong Suk Lee, Toronto (CA); Rob Miller, Mississauga (CA); Ashraf Metwalli, Toronto (CA)

(21) Appl. No.: 14/796,681

(22) Filed: Jul. 10, 2015

Related U.S. Application Data
(60) Provisional application No. 62/023,527, filed on Jul. 11, 2014.

(51) Int. Cl. G06Q 30/02; G06Q 20/10

(52) U.S. Cl. CPC G06Q 30/0226; G06Q 20/10

(57) ABSTRACT

A method of effecting an incentive transaction involves a computer server receiving a notification message that identifies a financial transaction. The server is in communication with a database of incentive plans, each comprising a plan definition that defines an incentive transaction. Each plan is associated with plan participants by participant identifiers. Each participant identifier is uniquely associated with their plan participant. The notification message includes a product code and the participant identifier of one plan participant. The server identifies an incentive plan applicable to the financial transaction from a correlation with the participant identifier, determines an incentive amount from the product code and the incentive plan definition of the applicable incentive plan, and initiates the incentive transaction for the incentive amount with a first financial account associated with the one plan participant and with a second financial account associated with another of the plan participants of the applicable incentive plan.

### RELATED APPLICATIONS

This patent application claims the benefit of the filing date of U.S. Patent Application Ser. No. 62/023,527 filed Jul. 11, 2014, the disclosure of which is hereby incorporated by reference in its entirety.

### FIELD OF THE INVENTION

This patent application relates to a method and network for incentivizing consumer behaviour.

### BACKGROUND

Loyalty programs reward customers for patronizing a particular merchant or group of participating merchants. Each customer may be provided with a payment card (e.g. debit card, credit card) or loyalty card and an associated loyalty account and/or financial account, and the loyalty program may add loyalty points to the customer's loyalty account whenever the customer uses the payment or loyalty card in a financial transaction with the merchant. The customer can then redeem all or a portion of the accumulated loyalty points towards rewards products (e.g. goods or services) available through the loyalty program. Alternately, the loyalty program may add a monetary credit to the financial account that is associated with the customer's payment card whenever the customer uses the payment card in a financial transaction with the merchant.

### SUMMARY

This patent application discloses a transaction server and associated method that determines the incentive plan(s) applicable to a financial transaction based on the product class(es) of the product(s) purchased in the transaction, and initiates an incentive transaction with an incentive account based on the applicable incentive plan(s). As used in this patent application, term “product” includes both goods/wares and services.

In accordance with a first aspect of the disclosure, there is provided a method of effecting a transaction using a data processor that is in communication with a database of incentive plans. Each incentive plan comprises an incentive definition and at least one participant identifier. Each incentive plan definition defines an incentive transaction to be transacted with an incentive account. Each incentive plan is associated with a plurality of incentive plan participants by the participant identifiers. Each participant identifier is uniquely associated with a respective one of the incentive plan participants. The incentive account is jointly associated with the plurality of incentive plan participants.

The data processor receives a transaction notification message identifying a financial transaction initiated by one of the plan participants at a payment terminal. The transaction notification message includes the participant identifier of the one plan participant, and also includes at least one product code each associated with a product being purchased in the financial transaction.

The data processor identifies at least one applicable incentive plan applicable to the financial transaction from a correlation with the participant identifier of the one plan participant of the transaction notification message. The data processor determines an incentive amount for the incentive transaction from the at least one product code and from the incentive plan definition of the at least one applicable incentive plan.

The data processor initiates the incentive transaction for the incentive amount with the incentive account of the at least one applicable incentive plan. The data processor provides at least the one plan participant with notification of particulars of the incentive transaction.

In accordance with the first aspect of the disclosure, there is also provided a transaction server that comprises a database of incentive plans, and a data processor that is coupled to the database. Each incentive plan of the database comprises an incentive definition and at least one participant identifier. Each incentive plan definition defines an incentive transaction to be transacted with an incentive account. Each incentive plan is associated with a plurality of incentive plan participants by the participant identifiers. Each participant identifier is uniquely associated with a respective one of the incentive plan participants. The incentive account is jointly associated with the plurality of incentive plan participants.

The data processor is configured to receive a transaction notification message identifying a financial transaction initiated by one of the plan participants at a payment terminal. The transaction notification message includes the participant identifier of the one plan participant, and also includes at least one product code each associated with a product being purchased in the financial transaction.

The data processor is configured to identify at least one applicable incentive plan applicable to the financial transaction from a correlation with the participant identifier of the one plan participant of the transaction notification message, and to determine an incentive amount for the incentive transaction from the at least one product code and from the incentive plan definition of the at least one applicable incentive plan.

The data processor is also configured to initiate the incentive transaction for the incentive amount with the incentive account of the at least one applicable incentive plan, and to provide at least the one plan participant with notification of particulars of the incentive transaction.

In accordance with a second aspect of the disclosure, there is provided a method of effecting a transaction using a data processor that is in communication with a database of incentive plans. Each incentive plan comprises an incentive definition and at least one participant identifier. Each incentive plan definition defines an incentive transaction to be transacted with an incentive account. Each incentive plan is associated with a plurality of incentive plan participants by the participant identifiers. Each participant identifier excludes particulars of the incentive account and is uniquely associated with a respective one of the incentive plan participants. The incentive account is jointly associated with the plurality of incentive plan participants.

The data processor receives from a payment terminal an electronic payment request message initiating electronic payment for a financial transaction by one of the plan participants. The electronic payment request message includes an account identifier, and also includes at least one product code each associated with a product being purchased in the financial transaction. The account identifier is associated with a payment account of the one plan participant. The payment account is distinct from the incentive account.

The data processor authorizes the electronic payment for the financial transaction from the payment account.

The data processor identifies at least one applicable incentive plan applicable to the financial transaction from a correlation with the participant identifier of the one plan participant of the transaction notification message. The data processor determines an incentive amount for the incentive transaction from the at least one product code and from the incentive plan definition of the at least one applicable incentive plan.

The data processor initiates the incentive transaction for the incentive amount with the incentive account of the at least one applicable incentive plan. The data processor provides the payment terminal with a payment confirmation message in response to the electronic payment request message.

In accordance with the second aspect of the disclosure, there is also provided a transaction server that comprises a database of incentive plans, and a data processor that is coupled to the database. Each incentive plan comprises an incentive definition and at least one participant identifier. Each incentive plan definition defines an incentive transaction to be transacted with an incentive account. Each incentive plan is associated with a plurality of incentive plan participants by the participant identifiers. Each participant identifier excludes particulars of the incentive account and is uniquely associated with a respective one of the incentive plan participants. The incentive account is jointly associated with the plurality of incentive plan participants.

The data processor is configured to receive from a payment terminal an electronic payment request message initiating electronic payment for a financial transaction by one of the plan participants. The electronic payment request message includes an account identifier, and also includes at least one product code each associated with a product being purchased in the financial transaction. The account identifier is associated with a payment account of the one plan participant. The payment account is distinct from the incentive account.

The data processor is configured to authorize the electronic payment for the financial transaction from the payment account.

The data processor is configured to identify at least one applicable incentive plan applicable to the financial transaction from a correlation with the participant identifier of the one plan participant of the transaction notification message, and to determine an incentive amount for the incentive transaction from the at least one product code and from the incentive plan definition of the at least one applicable incentive plan.

The data processor is configured to initiate the incentive transaction for the incentive amount with the incentive account of the at least one applicable incentive plan, and to provide the payment terminal with a payment confirmation message in response to the electronic payment request message.

In one implementation, each incentive plan definition specifies at least one product class, and the data processor determines the incentive amount by correlating the at least one product code with the at least one product class of the incentive plans. The data processor may be configured to identify the at least one applicable incentive plan by correlating the product class of the incentive plans with a product code that is not included in the transaction notification message.

Each incentive definition may include a plurality of weight factors each applicable to a respective one of the product classes, and the data processor may be configured to determine the incentive amount for the incentive transaction based on the weight factor of the at least one incentive plan of the one product class correlating with the at least one product.

Each plan participant may be associated with a respective second account that is distinct from the incentive account and the payment account, and the data processor may be configured to initiate the incentive transaction by effecting a transfer into the second accounts of the plan participants other than the one plan participant. Alternately, the data processor may be configured to initiate the incentive transaction by effecting a transfer from the second account of the one plan participant.

In accordance with a third aspect of the disclosure, there is provided a method of effecting a transaction using a data processor that is in communication with a database of incentive plans. Each incentive plan comprises an incentive definition and at least one participant identifier. Each incentive plan definition defines an incentive transaction and is associated with a plurality of incentive plan participants by the participant identifiers. Each participant identifier is uniquely associated with a respective one of the incentive plan participants.

The data processor receives a transaction notification message identifying a financial transaction initiated by one of the plan participants at a payment terminal. The transaction notification message includes the participant identifier of the one plan participant, and also includes at least one product code each associated with a product being purchased in the financial transaction.

The data processor identifies at least one applicable incentive plan applicable to the financial transaction from a correlation with the participant identifier of the one plan participant of the transaction notification message. The data processor determines an incentive amount for the incentive transaction from the at least one product code and from the incentive plan definition of the at least one applicable incentive plan.

The data processor initiates the incentive transaction for the incentive amount with a first account associated with the one plan participant and with a second account associated with another of the plan participants of the at least one applicable incentive plan.

In accordance with the third aspect of the disclosure, there is also provided a transaction server that comprises a database of incentive plans, and a data processor that is coupled to the database. Each incentive plan of the database comprises an incentive definition and at least one participant identifier. Each incentive plan definition defines an incentive transaction and is associated with a plurality of incentive plan participants by the participant identifiers. Each participant identifier is uniquely associated with a respective one of the incentive plan participants.

The data processor is configured to receive a transaction notification message identifying a financial transaction initiated by one of the plan participants at a payment terminal. The transaction notification message includes the participant identifier of the one plan participant, and also includes at least one product code each associated with a product being purchased in the financial transaction.

The data processor is configured to identify at least one applicable incentive plan applicable to the financial transaction from a correlation with the participant identifier of the one plan participant of the transaction notification message, and to determine an incentive amount for the incentive transaction from the at least one product code and from the incentive plan definition of the at least one applicable incentive plan.

The data processor is also configured to initiate the incentive transaction for the incentive amount with a first account associated with the one plan participant and with a second account associated with another of the plan participants of the at least one applicable incentive plan.

In one implementation, the transaction server provides at least the another of the plan participants with notification of particulars of the incentive transaction. The transaction server may provide the notification by providing the one plan participant with a transaction confirmation message, the transaction confirmation message providing the one plan participant with an opportunity to retroactively reverse the incentive transaction. The transaction server may provide the payment terminal with a payment confirmation message, in response to the transaction notification message, confirming authorization of an electronic payment for the financial transaction from the first account.

Since an incentive plan is determined for each product code included in the transaction notification message/electronic payment request message, plan participants may be incentivized to engage in behaviour (e.g. refrain from purchasing products, and/or encouraged to purchase other products) that has a positive impact on the value in their incentive account and thereby engage in behaviour that is beneficial to the plan participant.

### BRIEF DESCRIPTION OF THE DRAWINGS

An exemplary transaction server and method of effecting a transaction will now be described, with reference to the accompanying drawings, in which:

FIG. 1 is a schematic view of a transaction processing network, depicting a payment terminal, a transaction server, and a financial institution server;

FIG. 2 is a schematic view of the transaction server; and

FIG. 3 is a message flow diagram depicting the method of effecting a transaction implemented by the transaction server.

### DETAILED DESCRIPTION

### Transaction Processing Network

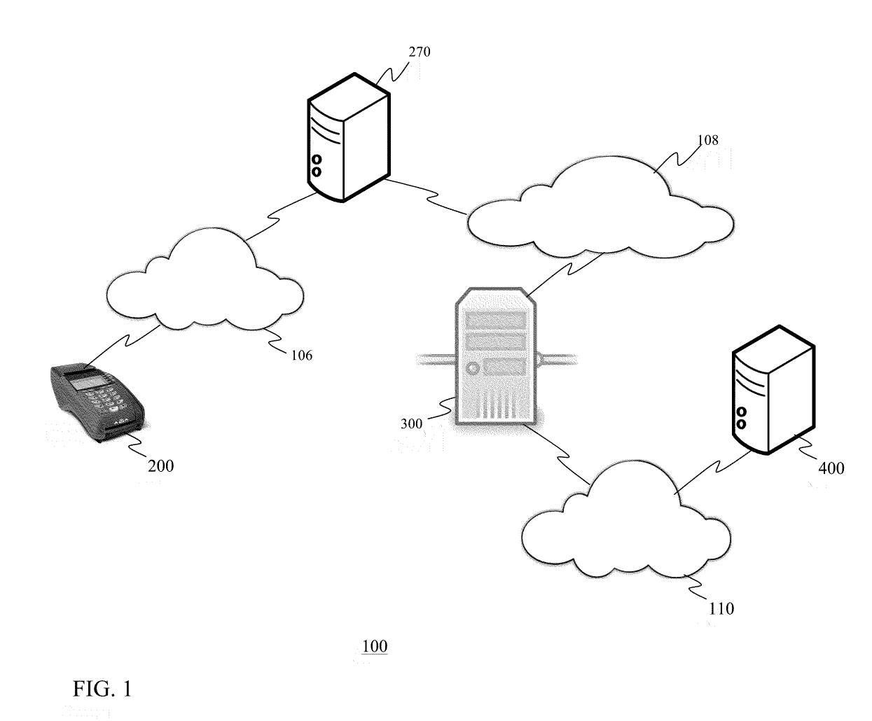

FIG. 1 is a schematic view of a transaction processing network, denoted generally as 100. As shown, the transaction processing network 100 comprises a payment terminal 200, an acquirer server 270, a financial institution server 300, and a transaction server 400. Although the payment processing network 100 is shown comprising only a single payment terminal 200, a single acquirer server 270, and a single financial institution server 300, the payment processing network 100 typically includes a plurality of the payment terminals 200, a plurality of the acquirer servers 270, and a plurality of the financial institution servers 300.

Typically, the payment terminals 200 are deployed at a respective merchant's business premises, and are configured to communicate with one of the acquirer servers 270 via a secure acquirer network 106. Alternately, the payment terminals 200 may be deployed remotely from the merchant's business premises, and configured to communicate with an online merchant server (not shown) via a wide area network (e.g. the Internet). As non-limiting examples, each payment terminal 200 may be implemented as an integrated point-of-sale (POS) terminal, a pin-pad terminal that communicates with an electronic cash register (ECR), or as a personal communications device (e.g. personal computer, smart phone).

In addition to the online merchant server (if deployed), the merchant may maintain a merchant price database that associates product codes with the current price information. As will be explained, each product offered for sale by the merchant is assigned a unique product code, and the payment terminals 200 may be configured to indirectly determine the current price of each product being purchased in a financial transaction by reading the product code of each product and querying the merchant price database for the current price information of the product. Alternately, the price information may be encoded in the product code, and the payment terminals 200 may be configured to directly determine the current price of the product by extracting the price information from the product code. Exemplary product codes include, but are not limited to, universal product codes (UPC), stock keeping units (SKU) and merchant category codes (MCC).

Each acquirer server 270 is associated with a financial institution of one or more merchants. Where the payment terminals 200 are configured as POS terminals or pin-pad terminals, the acquirer server 270 is configured to communicate with the payment terminals 200 via the acquirer network 106. Where the payment terminals 200 are configured as personal communications devices, the acquirer server 270 is configured to communicate with the online merchant server via the acquirer network 106. The acquirer servers 270 are also configured to communicate with the financial institution servers 300 via a payment network 108, such as VisaNet®, the Mastercard® Network or the Interac® Network, that is distinct from the acquirer network 106.

Each financial institution server 300 is associated with and administered by a respective financial institution. Each financial institution server 300 maintains financial accounts for each of a plurality of its customers, and is configured to communicate with the transaction server 400 via a wide area network 110, such as the Internet.

The transaction server 400 maintains or is in communication with a database of incentive plans, each associated with a plurality of incentive plan participants. Each incentive plan comprises an incentive plan definition and defines an incentive transaction. As will be discussed in detail below, the transaction server 400 is configured to receive a transaction notification message identifying a financial transaction initiated by one of the plan participants at a payment terminal. The transaction notification message includes a participant identifier of the one plan participant, and also includes at least one product code each associated with a product being purchased in the financial transaction.

The transaction server 400 is also configured to identify at least one incentive plan that is applicable to the financial transaction (from a correlation with the participant identifier of the one plan participant of the transaction notification message), and to determine an incentive amount for the incentive transaction from the at least one product code and from the incentive plan definition of the at least one applicable incentive plan.

Although the financial institution server 300 and the transaction server 400 are shown in FIG. 1 as being separate entities, the functionality of the transaction server 400 may be incorporated into one or more of the financial institution servers 300.

### Payment Terminal

The payment terminal 200 includes an input device, a display device, and a computer processing unit that is coupled to the input device and the display device. The input device may be implemented as a keyboard, touchpad, touchscreen or other input device suitable for allowing a user of the payment terminal 200 to input data and/or commands that may be required to complete the financial transaction. The display device may be implemented as a liquid crystal display (LCD) panel, cathode ray tube (CRT) display, plasma display panel, or other display device suitable for displaying transaction information to the user.

The payment terminal 200 may include a payment card interface that is coupled to the computer processing unit and configured to communicate with a payment card (e.g. credit card, debit card, loyalty card). The payment card is configured with a unique primary account number, and optionally also an expiry date and a personal identification number (PIN). As will be discussed, a financial institution issues (or authorizes a third party to issue) the payment card to a customer of the financial institution (cardholder), and maintains a financial account that is uniquely associated with the payment card.

The payment card may be implemented as a plastic card that has a contact form factor and/or a contactless (e.g. ISO 14443 based) form factor. If the payment card has a contact form factor, the payment card interface may comprise a physical port (e.g. smartcard reader) that allows the payment terminal 200 to communicate directly with the payment card. If the payment card has a contactless form factor, the payment card interface may comprise a wireless interface that allows the payment terminal 200 to communicate with the payment card via a wireless protocol, such as ISO 14443.

Alternately, the payment card may be implemented as software within a portable communications device, such as a smartphone, in which case the payment card interface may be configured to communicate with the payment card of the portable communications device using short-range communications protocols, such as Bluetooth and/or Near Field Communications (NFC) as examples.

As discussed, one or more of the payment terminals 200 may be interfaced with a respective ECR. Preferably, the ECR is configured with a keypad, keyboard, bar code scanner or other input device that allows the product code that is printed on or otherwise associated with a product to be input into the ECR.

### Financial Institution Server

Each financial institution server 300 is associated with and administered by a respective financial institution. The financial institution associated with the financial institution server 300 issues payment cards to cardholders (or authorizes a third party to issue the payment cards). Each financial institution server 300 is configured to communicate with the acquirer servers 270 via the payment network 108, and maintains a secure accounts database that includes a plurality of clusters each uniquely associated with a respective financial account. Each cluster is also uniquely associated with one of the payment cards, and typically identifies the primary account number of the associated payment card, and credit/deposit entries to the associated financial account.

### Transaction Server

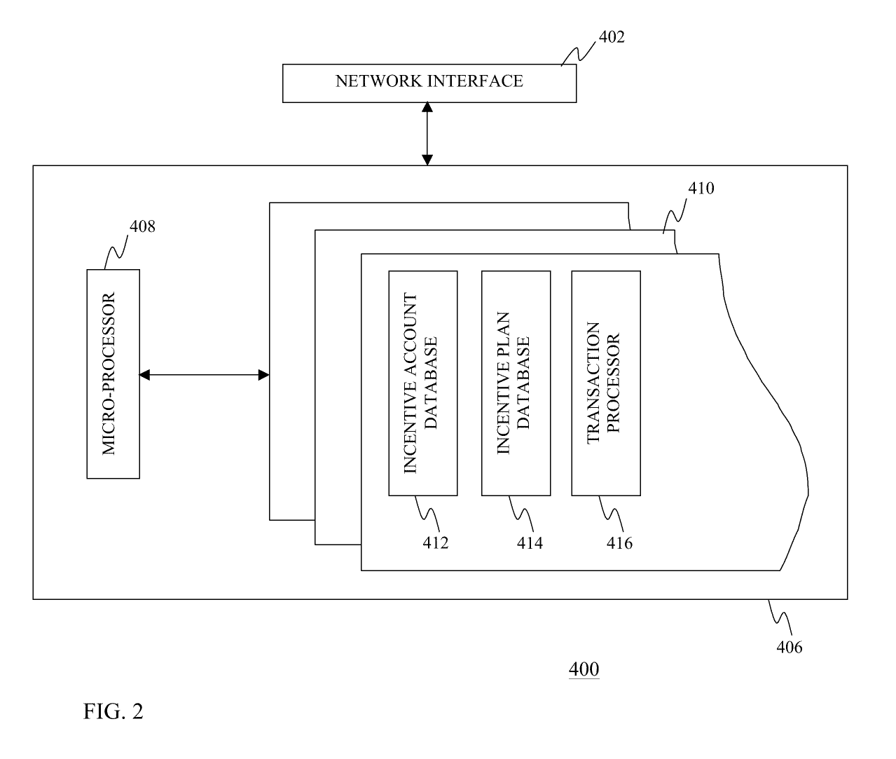

As shown in FIG. 2, the transaction server 400 includes a network interface 402, and a computer processing system 406 that is coupled to the network interface 402. The network interface 402 interfaces the transaction server 400 with the wide area network 110 and allows the transaction server 400 to communicate with the financial institution servers 300.

The computer processing system 406 may include one or more microprocessors 408 and a non-transient computer-readable medium 410. The computer-readable medium 410 may be provided as electronic computer memory (e.g. flash memory) or optical or magnetic memory (e.g. compact disc, hard disk) and maintains an incentive plan database 414.

In one embodiment, the memory 410 also maintains an incentive account database 412. Alternately, the incentive account database 412 may be maintained by the financial institution server 300, or deployed separately from the financial institution server 300 and the transaction server 400. The incentive account database 412 is a secure accounts database that includes a plurality of clusters each associated with a respective incentive account. Each cluster of the incentive account database 412 typically identifies an account number, and credit/deposit entries to the associated incentive account. The incentive account, as contemplated herein, is not limited to any particular form and may comprise, for example, a savings account, a chequing account, a credit account, a line of credit account, a loyalty points account and/or a business operating account. Although the incentive account may, therefore, comprise a financial account, and the financial institution server 300 also maintains financial accounts, the incentive accounts maintained in the incentive account database 412 are distinct from the financial accounts maintained by the financial institution server 300.

The incentive plan database 414 includes a plurality of clusters each associated with a respective incentive plan. Each cluster of the incentive plan database 414 comprises a plurality of database records that save for the associated incentive plan an incentive plan definition and particulars of one or more incentive plan participants. Each incentive plan definition defines an incentive transaction, and is associated with a plurality of incentive plan participants. In one embodiment, each incentive plan is associated with an incentive account of the incentive account database 412.

The incentive transaction may be a credit transaction and/or a debit transaction, and the incentive plan definition may specify a fixed incentive amount to be credited to and/or debited during the incentive transaction. Alternately, or additionally, the incentive plan definition may specify a variable incentive amount to be credited to and/or debited during the incentive transaction, based on, for example, the purchase price of the product purchased in the financial transaction or the total transaction amount of the financial transaction. Further, as will be explained below, the incentive plan definition may specify weight factors that are applicable to various product classes, and the variable incentive amount may be calculated based on the applicable weight factors. The incentive amount may also vary over the life of the incentive plan and/or with the completion of transaction milestones.

The product class(es) specified in an incentive plan definition are not limited to any particular predetermined class definition scheme, but may be defined in accordance with the goal(s) of the incentive plan. For example, if the goal of the incentive plan is to encourage consumption of certain products, the product class may list the product (e.g. fruits, vegetables) and/or the characteristics (e.g. citrus, seedless, country of origin) of the product encompassed by the incentive plan definition. If the goal of the incentive plan is to discourage consumption of certain products, the product class may list the product (e.g. cigarettes, vodka) and/or the characteristics (e.g. tobacco, alcohol content) of the product encompassed by the incentive plan definition.

The incentive plan definition may also specify combinations of products that must be purchased together (or must not be purchased together) to warrant a credit (or a debit from) during the incentive transaction. As an example, the incentive plan definition may specify a fixed credit incentive amount $X for products of Class A, a variable debit incentive amount calculated as a percentage % Y of the purchase price for products of Class B, and a fixed credit incentive amount $Z for products of Class C when not purchased together with a product of Class A.

In the above example, within each product class the variable incentive amount is a fixed percentage of the purchase price of each product encompassed by the product class. In one variation, within each product class the variable incentive amount is a variable percentage of the purchase price of each product encompassed by the product class. In this variation, the incentive plan definition may specify weight factors that are applicable to the respective product classes (and/or sub-classes of products within the product class), and the variable percentage may be calculated based on the weight factors that are applicable to the respective product classes (sub-classes).

As an example of this variation, the incentive plan definition may specify a variable debit incentive amount calculated as a percentage % Y of the purchase price for products of Class B, with products of sub-class B1 of Class B being assigned a weight factor of b1/10, products of sub-class B2 of Class B being assigned a weight factor of b2/10, and products of sub-class B3 of Class B being assigned a weight factor of b3/10.

In the preceding example, the variable incentive amount is based on fixed weight factors that are applied to the purchase price of the products within a product class. In one variation, the variable credit or debit incentive amount varies over the life of the incentive plan and/or with the completion of transaction milestones. As an example of this variation, the incentive plan definition may specify a variable credit incentive amount calculated as a first fixed amount $X1 (or a first fixed percentage % Y1 of the purchase price for products of Class B, or a first weight factor b1_{—}1/10 for products of sub-Class B1) over a first time interval, and a second fixed amount $X2 (or a second fixed percentage % Y2 of the purchase price for products of Class B, or a second weight factor b1_{—}2/10 for products of sub-Class B1) over a second time interval. The variable credit incentive amount may be calculated as a first fixed amount $X1 (or a first fixed percentage % Y1 of the purchase price for products of Class B, or a first weight factor b1_{—}1/10 for products of sub-Class B1) while the total cost or quantity of products of Class B purchased during the term of the incentive plan is less than a threshold amount, and a second fixed amount $X2 (or a second fixed percentage % Y2 of the purchase price for products of Class B, or a second weight factor b1_{—}2/10 for products of sub-Class B1) while the total cost or quantity of products of Class B purchased during the term of the incentive plan is not less than the threshold amount.

In the preceding examples, the incentive amount is calculated based on the presence of products from one or more product classes. In another variation, the incentive amount is calculated based on the absence of products from one or more product classes. In this variation, the incentive plan definition may specify a fixed (credit or debit) or variable (credit or debit) incentive amount that is awarded when the products being purchased do not include those of a particular product class. As an example of this variation, the incentive plan may specify a variable credit incentive amount calculated as a percentage % Y of the total authorization amount for all products being purchased in the financial transaction when none of the products being purchased are from Class A.

As discussed, each incentive plan is associated with a plurality of incentive plan participants. Therefore, the incentive account that is associated with the incentive plan definition (if the incentive plan is associated with an incentive account) is also jointly associated with the plurality of incentive plan participants.

The particulars of each incentive plan participant saved in the incentive plan database 414 includes an incentive plan participant identifier, and may also include the name of the incentive plan participant, and a contact address (phone number, e-mail address) at which the incentive plan participant can receive status information regarding the status of the associated incentive plan. Each participant of the incentive plan is uniquely associated with the respective incentive plan participant identifier. In the incentive plan database 414, each incentive plan is associated with its incentive plan participants by their respective participant identifiers. Preferably, each participant identifier excludes particulars of the associated incentive account (if the incentive plan is associated with an incentive account), and comprises a primary account number that is uniquely associated with the payment card that is issued to the incentive plan participant.

In addition to the incentive account database 412 (if included) and the incentive plan database 414, the computer-readable medium 410 may also include computer processing instructions stored thereon which, when executed by the microprocessor(s) 408, define an operating system (not shown) that controls the overall operation of the transaction server 400.

The computer processing instructions may also implement a transaction processor 416 that is configured to receive a transaction notification message that identifies a financial transaction initiated by one of the plan participants at one of the payment terminals 200. The transaction notification message includes the participant identifier of one plan participant, and also includes at least one product code each associated with a product being purchased in the financial transaction.

The transaction processor 416 is configured to identify at least one incentive plan that is applicable to the financial transaction, from a correlation with the participant identifier of the one plan participant of the transaction notification message, and to determine an incentive amount for the incentive transaction from the at least one product code and from the incentive plan definition of the at least one applicable incentive plan.

In one embodiment, the transaction processor 416 is configured to initiate the incentive transaction for the incentive amount with a first account associated with the one plan participant and with a second account associated with another of the plan participants of the at least one applicable incentive plan. In another embodiment, each incentive plan definition also specifies an incentive account for the incentive transaction, and the transaction processor 416 is configured to initiate the incentive transaction for the incentive amount with the incentive account of the at least one applicable incentive plan, and to provide at least the one plan participant with notification of particulars of the incentive transaction.

Although the transaction processor 416 is typically implemented as computer processing instructions, all or a portion of the functionality of the transaction processor 416 may be implemented instead in electronics hardware, such as a field programmable logic gate array (FPGA) or a complex programmable logic device (CPLD).

### Method of Effecting a Transaction

As discussed, the transaction processing network 100 implements a method of effecting a transaction. By way of overview of the method involves the transaction server 400 receiving a transaction notification message that identifies a financial transaction initiated by one of the plan participants at one of the payment terminals 200. The transaction notification message includes the participant identifier of the one plan participant, and also includes at least one product code each associated with a product being purchased in the financial transaction.

The transaction server 400 is in communication with the accounts database 412 and the incentive plan database 414. As discussed, each incentive plan of the incentive plan database 414 comprises an incentive plan definition and at least one participant identifier. Each incentive plan definition defines an incentive transaction and is associated with a plurality of incentive plan participants by their respective participant identifiers.

The transaction server 400 identifies at least one incentive plan that is applicable to the financial transaction from a correlation with the participant identifier of the one plan participant of the transaction notification message, and determines an incentive amount for the incentive transaction from the at least one product code and from the incentive plan definition of the at least one applicable incentive plan.

In one embodiment, the transaction server 400 initiates the incentive transaction for the incentive amount with a first account associated with the one plan participant and with a second account associated with another of the plan participants of the at least one applicable incentive plan. In another embodiment, each incentive plan definition of the incentive plan database 414 also specifies an incentive account for the incentive transaction, and the transaction server 400 initiates the incentive transaction for the incentive amount with the incentive account of the at least one applicable incentive plan, and provides at least the one plan participant with notification of particulars of the incentive transaction.

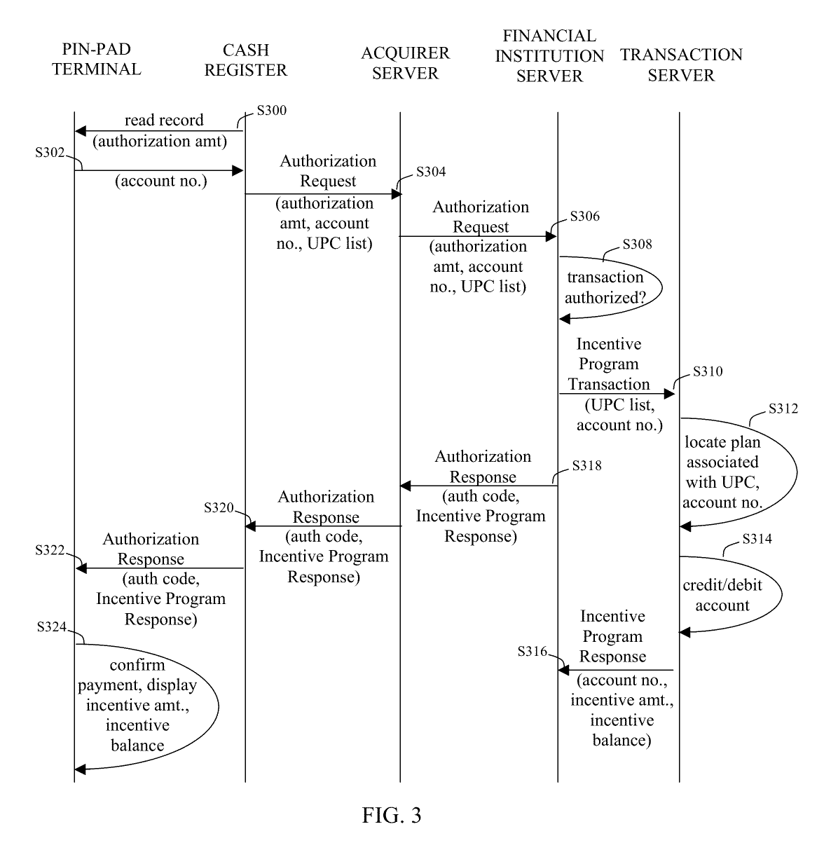

An example of the transaction effecting method will now be discussed in detail with reference to FIG. 3. In the following example, each product being offered for sale by a merchant is associated with a universal product code (UPC), and the payment terminal 200 is configured as a pin-pad terminal that communicates with an ECR. However, as discussed above, the payment terminal 200 is not limited to this particular configuration, and may instead by configured, for example, as a personal computing device that communicates with an online merchant server.

At the outset of the method, a customer (an incentive plan participant) attends at a payment terminal 200 of a merchant to complete a financial transaction (e.g. pay for one or more products) with the merchant. The merchant uses the keypad, keyboard, bar code scanner or other input device of the ECR to read/input the UPC of each product of the financial transaction.

For each UPC input into the ECR, the ECR may query the merchant price database with the UPC to determine the current price of the associated product. The ECR then calculates the sum of the purchase price of all the products being purchased in the financial transaction, generates a read record request message that includes the calculated sum (“authorization amount”), and transmits the read record request to the payment (pin-pad) terminal 200 at step S300.

The payment terminal 200 displays the authorization amount on the display device of the payment terminal, and prompts the customer to approve the displayed authorization amount using the input device of the payment terminal 200. The customer approves the displayed authorization amount, and the payment terminal 200 prompts the customer to interface a payment card with the payment card interface of the payment terminal 200.

After the customer (cardholder) interfaces a payment card with the payment terminal 200, the payment terminal 200 reads the primary account number from the payment card. Depending on the configuration of the payment card and the payment terminal 200, the payment terminal 200 may generate a payment card cryptogram from the authorization amount and a private cryptographic key stored on the payment card. At step S302, the payment terminal 200 responds to the ECR with the primary account number of the customer's payment card and the payment card cryptogram (if generated).

At step S304, the ECR generates an Authorization Request message that includes the authorization amount, primary account number, and a list of the UPCs (and associated purchase price) of each product (“UPC list”) being purchased in the financial transaction (and optionally the payment card cryptogram), and forwards the Authorization Request message to the acquirer server 270 via the acquirer network 106. At step S306, the Authorization Request message is directed from the acquirer server 270 to the one of the financial institution servers 300, via the payment network 108, for validation. Typically the payment network 108 uses the primary account number of the Authorization Request Message to direct the Authorization Request message to the financial institution server 300 that maintains the financial account associated with the primary account number.

At step S308, the financial institution server 300 determines whether the financial transaction can be authorized by determining whether the financial account that is associated with the primary account number is still active and has sufficient credit/funds to complete the transaction. If the Authorization Request message included a payment card cryptogram, the financial institution server 300 may also determine whether the payment card cryptogram is valid.

If the financial institution determines that the financial transaction can be authorized, the financial institution server 300 generates an Incentive Program Transaction message that includes the primary account number and UPC list, and forwards the Incentive Program Transaction message to the transaction server 400, at step S310.

At step S312, the transaction server 400 identifies, in substantially real-time, the incentive plan(s), if any, that are applicable to the financial transaction, from a correlation of the incentive plans in the incentive plan database 414 with at least the primary account number of the Incentive Program Transaction message. To identify the applicable incentive plan(s), the transaction server 400 may first query the incentive plan database 414 with the primary account number (incentive plan participant identifier) included in the Incentive Program Transaction message to locate the incentive plan(s) (if any) that is/are associated with the primary account number.

From the incentive plan(s) that is/are associated with the primary account number, the transaction server 400 may identify the applicable incentive plan(s) by correlating the product code of each product identified in the Incentive Program Transaction message with the product class(es) identified in the incentive plan definition of each located incentive plan. To do so, the transaction server 400 may query the incentive plan definition of each located incentive plan with each UPC included in the UPC list, thereby identifying the incentive plan(s) that is/are applicable to the financial transaction and the products that are covered by an applicable incentive plan.

At step S314, the transaction server 400 determines, in substantially real-time, the incentive amount (if any) for the incentive transaction(s) defined in the applicable incentive plan(s), from the product code of each product identified in the Incentive Program Transaction message and from the incentive plan definition of the incentive plan(s) that is(are) identified as being applicable to the financial transaction. To determine the incentive amount for the incentive transaction(s), the transaction server 400 may apply each UPC included in the UPC list, and optionally the purchase price of the associated product, as an input to the incentive plan definition of the applicable incentive plan(s). The transaction server 400 may then initiate, in substantially real-time, the incentive transaction(s) for the respective incentive amount(s) specified by the applicable incentive plan(s).

In accordance with the applicable incentive plan(s), in a first embodiment the transaction server 400 may initiate the incentive transaction(s) each for the respective incentive amount(s) with a first account that is associated with the customer (cardholder) and with one or more second accounts that are each respectively associated with other plan participants of the applicable incentive plan(s). The first account typically comprises the financial account that is associated with the primary account number included in the Incentive Program Transaction message. The transaction server 400 may complete each incentive transaction by directing the financial institution server 300 to credit (or debit) the incentive amount to (or from) the (first) account of the customer (cardholder), and to debit (or credit) a corresponding amount from (or to) the (second) account of the other plan participant(s).

Alternately, in accordance with the applicable incentive plan(s), in a second embodiment the transaction server 400 may initiate the incentive transaction(s) each for the respective incentive amount(s) with the incentive account(s) specified by the applicable incentive plan(s). As discussed, the incentive account is distinct from the financial account that is associated with the primary account number included in the Incentive Program Transaction message. The transaction server 400 may complete each incentive transaction by directing the financial institution server 300 to credit (or debit) the incentive amount to (or from) the incentive account, and to debit (or credit) a corresponding amount from (or to) a second account that is associated with the applicable incentive plan, but that is distinct from the incentive account and from the financial account that is associated with the primary account number.

As non-limiting examples of this second embodiment, the second accounts that are associated with the applicable incentive plan may be funded or maintained by a financial institution, a charity or the product manufacturer of products encompassed by the product class(es) associated with the applicable incentive plan(s). The charity may operate the transaction server 400, or may be the beneficial owner of the second accounts and distinct from the operator of the transaction server 400.

In one variation of this second embodiment, the second accounts that are associated with the applicable incentive plan are funded by the participants of the applicable incentive plan(s). In this variation, the transaction server 400 may complete the incentive transactions by effecting a transfer from the incentive account into the second accounts of the plan participants other than the plan participant associated with the primary account number. Alternately, the transaction server 400 may complete the incentive transactions by effecting a transfer into the incentive account from the second account of the plan participant associated with the primary account number.

Referring to the first example discussed above (where the incentive plan definition specifies a fixed credit incentive amount $X for products of Class A, a variable debit incentive amount calculated as a percentage % Y of the purchase price for products of Class B, and a fixed credit incentive amount $Z for products of Class C when not purchased together with a product of Class A), if the UPC list included products of Classes A, B and C the transaction server 400 would credit the incentive account (or direct the financial institution server 300 to credit the first account, if applicable) $X for each product of Class A (and would direct the financial institution server 300 to debit a corresponding amount from the second account(s) associated with the incentive plan), and would debit the incentive account (or direct the financial institution server 300 to debit the first account, if applicable) an amount equal to % Y×purchase price of each product of Class B (and would direct the financial institution server 300 to credit a corresponding amount to the second account(s) associated with the incentive plan), but would not credit the incentive account (or direct the financial institution server 300 to credit the first account, if applicable) for any product of Class C.

In other words, where the incentive plan is not associated with an incentive account, in the foregoing example the transaction server 400 would direct the financial institution server 300 to transfer funds in the amount of $X from the second account directly into the first account, and to transfer funds in the amount of % Y from the first account directly into the second account (i.e. without transferring funds through an incentive account). Where the incentive plan is associated with an incentive account, in the foregoing example the transaction server 400 would direct the financial institution server 300 to transfer funds in the amount of $X from the incentive account into the second account(s), and to transfer funds in the amount of % Y from the incentive account into the second account(s).

If the UPC list included products of Classes B and C, but no products of Class A, the transaction server 400 would debit the incentive account (or direct the financial institution server 300 to debit the first account, if applicable) an amount equal to % Y×purchase price of each product of Class B (and direct the financial institution server 300 to credit a corresponding amount to the second account(s) associated with the incentive plan), and would credit the incentive account (or direct the financial institution server 300 to credit the first account, if applicable) $Z for each product of Class C (and direct the financial institution server 300 to debit a corresponding amount from the second account(s) associated with the incentive plan).

As discussed above, the incentive account may be a business operating account. Therefore, in one implementation of the foregoing example, the incentive account is a business operating account maintained by a financial institution (e.g. for the purpose of at least implementing the incentive transactions), the second account is a financial account maintained at the financial institution, the fixed credit incentive amount $X (or $Z) is a service charge credit, and the transaction server 400 directs the financial institution server 300 to apply the service charge credit $X (or $Z) to the second financial account (and would debit a corresponding amount from the incentive business operating account).

Referring to the second example discussed above (where the incentive plan definition specifies a variable debit incentive amount calculated as a percentage % Y of the purchase price for products of Class B, with products of sub-class B1 of Class B being assigned a weight factor of b1/10, products of sub-class B2 of Class B being assigned a weight factor of b2/10, and products of sub-class B3 of Class B being assigned a weight factor of b3/10), if the UPC list included products of subclasses B1, B2 and B3 the transaction server 400 would debit the incentive account (or direct the financial institution server 300 to debit the first account, if applicable) an amount equal to (b1/10)×% Y×purchase price of each product of subclass Class B1, an amount equal to (b2/10)×% Y×purchase price of each product of subclass Class B2, and an amount equal to (b3/10)×% Y×purchase price of each product of subclass Class B3 (and direct the financial institution server 300 to credit corresponding amounts to the second account(s) associated with the incentive plan).

Referring to the third example discussed above (where the incentive plan definition specifies a variable credit incentive amount calculated as a first fixed amount $X1 (or a first fixed percentage % Y1) for a first time interval, and a second fixed amount $X2 (or a second fixed percentage % Y2) for a second time interval), if the UPC list included products of Class B the transaction server 400 would credit the incentive account (or direct the financial institution server 300 to credit the first account, if applicable) $X1 (or an amount equal to % Y1×purchase price of each product of Class B) during the first time interval (and direct the financial institution server 300 to debit a corresponding amount from the second account(s) associated with the incentive plan), and would credit the incentive account (or direct the financial institution server 300 to credit the first account, if applicable) an amount $X2 (or an amount equal to % Y2×purchase price of each product of Class B) during the second time interval (and direct the financial institution server 300 to debit a corresponding amount from the second account(s) associated with the incentive plan).

Again referring to the third example discussed above (where the incentive plan definition specifies a variable credit incentive amount calculated as a first fixed amount $X1 (or a first fixed percentage % Y1) while the total cost or quantity of products of Class B purchased during the term of the incentive plan is less than a threshold amount, and a second fixed amount $X2 (or a second fixed percentage % Y2) while the total cost or quantity of products of Class B purchased during the term of the incentive plan is not less than the threshold amount), if the UPC list included products of Class B the transaction server 400 would credit the incentive account (or direct the financial institution server 300 to credit the first account, if applicable) $X1 (or an amount equal to % Y1×purchase price of each product of Class B) while the total cost or quantity of products of Class B purchased during the term of the incentive plan is less than the threshold amount (and direct the financial institution server 300 to debit a corresponding amount from the second account(s) associated with the incentive plan), and would credit the incentive account (or direct the financial institution server 300 to credit the first account, if applicable) an amount $X2 (or an amount equal to % Y2×purchase price of each product of Class B) while the total cost or quantity of products of Class B purchased during the term of the incentive plan is not less than the threshold amount (and direct the financial institution server 300 to debit a corresponding amount from the second account(s) associated with the incentive plan).

Alternately, at step S312, after locating the incentive plan(s) that is/are associated with the primary account number, the transaction server 400 may identify the incentive plan(s) that is/are applicable to the financial transaction by querying the UPC list with the incentive plan definition of each located incentive plan, thereby identifying the incentive plan(s) that is/are applicable to the financial transaction.

For each applicable incentive plan, at step S314 the transaction server 400 may then use the incentive plan definition thereof to determine the incentive amount (if any) that is applicable to the financial transaction. To determine the incentive amount for the incentive transaction(s), the transaction server 400 may apply the UPC of the products being purchased, the purchase price of the products and/or the total authorization amount for the transaction, as inputs to the incentive plan definition of the applicable incentive plan(s).

Referring to the fourth example discussed above (where the incentive plan definition specifies a variable credit incentive amount calculated as a percentage % Y of the total authorization amount for the financial transaction when none of the products being purchased in the financial transaction are from Class A), if the UPC list included products of Classes B and C, but excluded products of Class A, the transaction server 400 would credit the incentive account (or direct the financial institution server 300 to credit the first account, if applicable) an amount equal to % Y×the total authorization amount (and direct the financial institution server 300 to debit a corresponding amount from the second account(s) associated with the incentive plan).

After crediting/debiting the incentive account (or the first account, as applicable) with the incentive amount, the transaction server 400 may generate a transaction confirmation message that identifies the incentive amount transferred and includes a time-limited over-ride code that allows the incentive plan participant (customer, cardholder) that triggered the incentive transaction to optionally reverse the incentive transaction. The transaction server 400 may query the incentive plan database 414 for the contact address of the customer, and transmit the transaction confirmation message to the customer at the customer's contact address. Alternately, the customer may have installed onto the customer's personal communications device a notification software application that may have been configured with the customer's unique participant identifier by the Transaction Processing Network 100 during a customer registration phase, and the transaction server 400 may transmit the transaction confirmation message to the notification software application that is configured with the customer's unique participant identifier. This optional notification feature provides the customer with a time-limited opportunity to retroactively exclude a financial transaction from the operation of the transaction server 400 by transmitting the over-ride code back to the transaction server 400 before expiry of the over-ride code.

The transaction server 400 may generate a transaction status update message that provides particulars of the incentive transaction, including the incentive amount transferred into/from the incentive account, the current balance of the incentive account, the name of the customer, and the product that the customer purchased (or did not purchase) that triggered the incentive transaction. The transaction server 400 may notify all the incentive plan participants of the incentive transaction by querying the incentive plan database 414 for the contact address of each incentive plan participant associated with the incentive plan, and transmitting the transaction status update message to the incentive plan participants at their respective contact addresses (or to the notification software applications that are configured with the participants' respective unique participant identifiers).

The transaction server 400 may also compile statistical information from each incentive transaction (e.g. most common products purchased for each incentive plan, most common types of payment cards used with each incentive plan), and may make the statistical information available to subscribers of the transaction processing network 100 (e.g. merchants, product manufacturers).

At step S316, the transaction server 400 optionally provides the customer (incentive plan participant) with notification of particulars of the incentive transaction by generating an Incentive Program Response message that identifies the primary account number, the incentive amount (and the current balance of the incentive account, if applicable), and returns the Incentive Program Response message to the financial institution server 300.

At step S318, the financial institution server 300 generates an authorization response code that indicates whether the financial institution authorized or declined the financial transaction at step S308, generates an Authorization Response message that includes the authorization response code and optionally the Incentive Program Response message, and directs the Authorization Response message to the acquirer server 270 via the payment network 108. At step S320, the acquirer server 270 forwards the Authorization Response Message to the ECR, via the acquirer network 106.

At step S322, the ECR forwards the Authorization Response message to the payment terminal 200. If the authorization response code indicates that the financial institution authorized the financial transaction, at step S324 the payment terminal 200 generates a payment confirmation message confirming that the financial transaction was authorized and optionally also identifies the incentive amount (and the current balance of the incentive account, if applicable). Thereafter (typically at the end of the business day), the merchant uses the payment terminal 200 to effect clearance and settlement, in the conventional manner, of all financial transactions that were authorized by the financial institution server 300.

In one variation, the ECR does not include the UPC list in the Authorization Request message at step S304. At step S306, the acquirer server 270 directs the Authorization Request message to the financial institution server 400, and the financial institution server 400 authorizes the financial transaction at step S308, as discussed above. Processing then proceeds directly to step S318. However, in this variation, at step S318 the financial institution server 400 does not include the Incentive Program Response message in the Authorization Response message. At step S320, the acquirer server 270 forwards the Authorization Response Message to the ECR, and the ECR forwards the Authorization Response message to the payment terminal 200 at step S322, as discussed above.

Thereafter (typically at the end of the business day), the merchant uses the payment terminal 200 to effect clearance and settlement of all the financial transactions that were authorized by the financial institution server 300. However, in contrast to the conventional clearance and settlement process, the batch clearance message transmitted by the payment terminal 200 to the acquirer server 270 includes the UPC list for each authorized financial transaction.

For each financial transaction identified in the batch clearance message, the financial institution server 300 associated with the financial transaction uses the respective UPC list to generate an Incentive Program Transaction message, and forwards the Incentive Program Transaction message to the transaction server 400 (as discussed above with reference to step S310). The transaction server 400 identifies the incentive plan(s) that is/are applicable to the financial transaction (as discussed above with reference to step S312), determines the incentive amount (if any) that is applicable to the purchase of each product, and uses the incentive plan definition to initiate an incentive transaction for the incentive amount (as discussed above with reference to step S314).

For each financial transaction, the transaction server 400 may generate an Incentive Program Response message that identifies the primary account number, the incentive amount (and the current balance of the incentive account, if applicable), and return the Incentive Program Response message to the financial institution server 300 (as discussed above with reference to step S316). For each Incentive Program Response message, the financial institution server 300 may post the Incentive Program Response message to the associated financial account to thereby notify the customer of the incentive amount awarded for the financial transaction (and the current balance of the incentive account, if applicable).

What is claimed is:

1. A method of effecting an incentive transaction using a computer server, the computer server being in communication with a database of incentive plans, each said incentive plan comprising an incentive plan definition and at least one participant identifier, each said incentive plan definition defining an incentive transaction, each said incentive plan being associated with a plurality of incentive plan participants by the at least one participant identifiers, each said participant identifier being uniquely associated with a respective one of the incentive plan participants, the method comprising:
the computer server receiving a transaction notification message identifying a financial transaction initiated by one of the plan participants at a payment terminal, the transaction notification message including the participant identifier of the one plan participant and at least one product code each associated with a product being purchased in the financial transaction;
the computer server identifying at least one applicable incentive plan applicable to the financial transaction from a correlation with the participant identifier of the one plan participant of the transaction notification message;
the computer server determining an incentive amount for the incentive transaction from the at least one product code and from the incentive plan definition of the at least one applicable incentive plan; and
the computer server initiating the incentive transaction for the incentive amount with a first account associated with the one plan participant and with a second account associated with another of the plan participants of the at least one applicable incentive plan.

2. The method according to claim 1, wherein each said incentive plan definition specifies at least one product class, and the determining an incentive amount comprises the computer server correlating said at least one product code with the at least one product class of the incentive plans.

3. The method according to claim 2, wherein each said incentive definition includes a plurality of weight factors each applicable to a respective one of the product classes, and the determining the incentive amount comprises the computer server determining the incentive amount for the incentive transaction based on the weight factor of the at least one applicable incentive plan of the one product class correlating with the at least one product code.

4. The method according to claim 1, wherein each said incentive plan definition includes a product class, and the identifying at least one applicable incentive plan comprises the computer server correlating the product class of the incentive plans with a product code excluded from the transaction notification message.

5. The method according to claim 1, wherein the incentive amount defined by one of the incentive plan definitions varies over a life of the associated incentive plan.

6. The method according to claim 1, wherein the incentive amount defined by one of the incentive plan definitions varies with completion of a transaction milestone.

7. The method according to claim 1, wherein the computer server initiating the incentive transaction comprises the computer server effecting a funds transfer directly between the first account and the second account.

8. The method according to claim 1, further comprising the computer server providing at least the another of the plan participants with notification of particulars of the incentive transaction.

9. The method according to claim 8, wherein the providing at least the another of the plan participants with notification comprises the computer server providing the one plan participant with a transaction confirmation message, the transaction confirmation message providing the one plan participant with an opportunity to retroactively reverse the incentive transaction.

10. The method according to claim 1, further comprising the computer server providing the payment terminal with a payment confirmation message in response to the transaction notification message, the payment confirmation message confirming authorization of an electronic payment for the financial transaction from the first account.

11. A transaction processor comprising:
a database of incentive plans, each said incentive plan comprising an incentive plan definition and at least one participant identifier, each said incentive plan definition defining an incentive transaction, each said incentive plan being associated with a plurality of incentive plan participants by the at least one participant identifiers, each said participant identifier being uniquely associated with a respective one of the incentive plan participants; and
a data processor coupled to the database and configured to:
(i) receive a transaction notification message identifying a financial transaction initiated by one of the plan participants at a payment terminal, the transaction notification message including the participant identifier of the one plan participant and at least one product code each associated with a product being purchased in the financial transaction;
(ii) identify at least one applicable incentive plan applicable to the financial transaction from a correlation with the participant identifier of the one plan participant of the transaction notification message;
(iii) determine an incentive amount for the incentive transaction from the at least one product code and from the incentive plan definition of the at least one applicable incentive plan; and
(iv) initiate the incentive transaction for the incentive amount with a first account associated with the one plan participant and with a second account associated with another of the plan participants of the at least one applicable incentive plan.

12. The transaction processor according to claim 11, wherein each said incentive plan definition specifies at least one product class, and the data processor is configured to determine the incentive amount by correlating said at least one product code with the at least one product class of the incentive plans.

13. The transaction processor according to claim 12, wherein each said incentive definition includes a plurality of weight factors each applicable to a respective one of the product classes, and the data processor is configured to determine the incentive amount for the incentive transaction based on the weight factor of the at least one applicable incentive plan of the one product class correlating with the at least one product code.

14. The transaction processor according to claim 11, wherein each said incentive plan definition includes a product class, and the data processor is configured to identify the at least one applicable incentive plan by correlating the product class of the incentive plans with a product code excluded from the transaction notification message.

15. The transaction processor according to claim 11, wherein the data processor is configured to vary the incentive amount over a life of the incentive plan associated with one of the incentive plan definitions.

16. The transaction processor according to claim 11, wherein the data processor is configured to initiate the incentive transaction by effecting a funds transfer directly between the first account and the second account.

17. The transaction processor according to claim 11, wherein the data processor is configured to vary the incentive amount with completion of a transaction milestone defined by one of the incentive plan definitions.

18. The transaction processor according to claim 11, wherein the data processor is configured to provide at least the another of the plan participants with notification of particulars of the incentive transaction.

19. The transaction processor according to claim 18, wherein the data processor is configured to provide at least the another of the plan participants with notification by providing the one plan participant with a transaction confirmation message, the transaction confirmation message providing the one plan participant with an opportunity to retroactively reverse the incentive transaction.

20. A computer readable medium storing a database of incentive plans, each said incentive plan comprising an incentive plan definition and at least one participant identifier, each said incentive plan definition defining an incentive transaction, each said incentive plan being associated with a plurality of incentive plan participants by the at least one participant identifiers, each said participant identifier being uniquely associated with a respective one of the incentive plan participants, the computer readable medium carrying non-transient computer processing instructions stored thereon which, when executed by a computer, cause the computer to perform a method comprising:
receiving from a financial institution server a transaction notification message identifying a financial transaction initiated by one of the plan participants at a payment terminal, the transaction notification message including the participant identifier of the one plan participant and at least one product code each associated with a product being purchased in the financial transaction;
identifying at least one applicable incentive plan applicable to the financial transaction from a correlation with the participant identifier of the one plan participant of the transaction notification message;
determining an incentive amount for the incentive transaction from the at least one product code and from the incentive plan definition of the at least one applicable incentive plan; and
initiating the incentive transaction for the incentive amount with a first account associated with the one plan participant and with a second account associated with another of the plan participants of the at least one applicable incentive plan.

21. The computer readable medium according to claim 20, wherein each said incentive plan definition specifies at least one product class, and the determining an incentive amount comprises correlating said at least one product code with the at least one product class of the incentive plans.

22. The computer readable medium according to claim 21, wherein each said incentive definition includes a plurality of weight factors each applicable to a respective one of the product classes, and the determining the incentive amount comprises determining the incentive amount for the incentive transaction based on the weight factor of the at least one applicable incentive plan of the one product class correlating with the at least one product code.

23. The computer readable medium according to claim 20, wherein each said incentive plan definition includes a product class, and the identifying at least one applicable incentive plan comprises correlating the product class of the incentive plans with a product code excluded from the transaction notification message.

24. The computer readable medium according to claim 20, wherein the incentive amount defined by one of the incentive plan definitions varies over a life of the associated incentive plan.

25. The computer readable medium according to claim 20, wherein the incentive amount defined by one of the incentive plan definitions varies with completion of a transaction milestone.

26. The computer readable medium according to claim 20, wherein the initiating the incentive transaction comprises effecting a funds transfer directly between the first account and the second account.
